(19) United States
(12) Patent Application Publication
(10) Pub. No.: US 2012/0027642 A1
(43) Pub. Date: Feb. 2, 2012

(54) Luminometer or Fluorometer with an Injection Device

(75) Inventors: Fritz BERTHOLD, Pforzheim (DE); Wilfried Reuter, Straubenhardt (DE)

(73) Assignee: Berthold Technologies GmbH & Co. KG, Bad Wildbad (DE)

(21) Appl. No.: 13/194,673

(22) Filed: Jul. 29, 2011

(30) Foreign Application Priority Data
Jul. 29, 2010 (DE) 20 2010 010 821.7

(51) Int. Cl. G01N 21/76; G01N 21/64

(52) U.S. Cl. 422/52; 422/82.08

(57) ABSTRACT

Described is a luminometer or fluorometer having an optical axis which extends essentially perpendicular to the measuring sample. The detector for the luminometer or the fluorometer is arranged either directly or via a deflection means in the optical axis. An injection device (20) with an injection channel is provided for feeding in the reagents, wherein the injection channel consists of a first section and a second section, arranged at an angle relative to the first section, and is provided with a discharge opening (24c) that points in the direction of the measuring sample. To achieve a high sensitivity and a broad application range, the first section of the injection channel extends essentially perpendicular to the optical axis and at least one second injection device is provided which also comprises an injection channel with two sections, wherein the first section extends essentially perpendicular to the optical axis and the second section is angled relative to the first section and which ends in a discharge opening (24c′, 24c″).

### BACKGROUND OF THE INVENTION

1. Technical Field

The invention relates to a luminometer or fluorometer provided with an injection device, as disclosed in the preamble to claim 1.

2. Related Art

Bioluminescence and chemiluminescence, frequently referred to only as luminescence, are used to detect bacterial contamination in medicines and in food items, in the molecular-biological research, or in the laboratory diagnostic in the form of luminescence immunoassays.

The devices required for providing quantitative proof of the luminescence light are called luminometers. Since the amounts of light to be detected are extremely small, the highest possible degree of sensitivity is necessary which, as a rule, can only be achieved by using photomultipliers. The same is also true for the fluorescence measurements where the corresponding devices are called fluorometers.

Used as sample containers are individual tubes or the so-called microplates or microtiter plates, which are primarily used nowadays. The latter contain small wells arranged in lines or rows for accommodating the samples, wherein the number of samples on each plate can be 96, 384 or 1,536.

The sensitivity of a luminometer or fluorometer is one of its most important specifications. This sensitivity is primarily determined by the features of the photomultiplier being used. Among other things, these features include the surface area of the photocathode, the quantum yield in the wavelength of interest, as well as the background noise or the zero effect. The highest sensitivity is achieved when operating the photomultiplier as a photon counter. Furthermore important is the efficiency of the “transfer optics” that determines which share of the light emitted by the sample impinges on the photocathode of the multiplier.

A particular problem with luminescence measurements is the crosstalk, meaning the distortion of the measurement of a sample in the measuring position through interference from additional light emitted by other samples which are not in the measuring position.

The degree of interference of the measurements caused by the crosstalk depends essentially on the kinetics of the luminescence reaction. A distinction is made between “flash” and “glow” luminescence. With the flash luminescence, the light emission practically starts immediately after the injection of the so-called starter reagent that triggers the light emission, typically reaches its maximum after 0.3-1.0 seconds, and then decreases rapidly over several seconds. With the glow luminescence, on the other hand, a plateau with nearly constant light emission is reached sometime after the starter reagent is injected, wherein the light emission drops only gradually, for example only a few percentages over 10 minutes.

With the flash luminescence, the starter reagent must be injected directly into the sample located in the measuring position. The samples which have not been measured do not yet emit light and the previously measured samples emit only a weak after-light.

The situation is different for the glow luminescence where the measured samples still have a strong after-light long thereafter and where non-measured samples already emit luminescence if the starter reagent has been added prior to the measuring operation. For that reason, the danger of crosstalk is higher with the glow luminescence.

A reagent injection while the sample is in the measuring position is frequently required even with the fluorescence measurements to be able to follow from the start the effect that an added reagent has on the fluorescence intensity.

Thus, for many applications, the tip of the injection device must be located directly above the sample and it must be ensured with structural measures that the lowest possible amount of light is lost on the way to the detector. Also important are practical aspects such as the minimizing of the danger of contaminating the device with the chemicals that are used, as well as an easy cleaning and the production costs.

With a luminometer of the generic type as disclosed in the EP 1279949, a reflector which widens with an increased diameter in the direction of the detector is arranged between the sample and the detector, so as to ensure that the maximum amount of light reaches the detector. An injector provided with an injection channel extends through this reflector, wherein the injection channel comprises two sections. The second section in this case is angled, relative to the first section, and is provided with an exit opening pointing toward the sample to be measured.

With the luminometer according to the DE 20 2008 016 208, a reflector optics is also arranged between the sample and the detector, which in this case takes the form of a section of a rotation ellipsoid with vapor deposition on the inside. In both cases, a straight-line reagent feeding device extends through the reflecting wall and ends in a tip positioned above the sample. The reagent can be fed in vertically from above or at a slight angle thereto. In any case, the photocathode therefore cannot be positioned directly above the entrance aperture. The purpose of the reflectors consequently is to achieve a high sensitivity despite the of necessity longer distance to the photocathode.

However, it has proven to be a serious disadvantage of these types of reflectors that the reflecting properties in nearly all cases worsen more or less over time, in particular as a result of vapors or spatters from the reagents. The sensitivity of the luminometer thus decreases over time, which also results in making it impossible to directly compare measurements that were taken at different times.

In the case of the glow luminescence, the solution to this problem is simple. The photocathode of the photomultiplier is positioned directly above the sample, separated only by the entrance aperture from the sample, so that a reflector is not even required.

The situation is different for the flash luminescence where an injection device must also be arranged between the sample and the detector, so that the detector must be positioned at a longer distance to the sample. As a result, the sensitivity is initially reduced and is then compensated again by the reflecting surfaces with the above-described disadvantages.

The same is true for the fluorometers for which also the lowest possible amount of light should be absorbed by the injection device.

### SUMMARY OF THE INVENTION

It is the object of the present invention to modify a generic luminometer and fluorometer in such a way that the above-described problems are avoided or at least mitigated, and offer a large range of uses.

This object is solved with a luminometer or a fluorometer having the features as disclosed in claim 1.

To move the detector of a luminometer which as a rule is the photocathode of a photomultiplier as close as possible to the sample, the reagent is fed in practically horizontal from the side and the feed-in tube is only bent to point “downward” once it is directly above the sample. At least two injection devices embodied in this way are provided, so that more than one reagent can optionally be injected into the sample that is positioned in the measuring position, and/or to inject a reagent prior to the actual sample measuring, wherein the sample in that case is not yet positioned in the measuring position.

The same arrangement can also be used advantageously for the fluorometers. In that case, the emitted light first moves through the injection region, then impinges on the lenses or reflector optics, subsequently passes through an optical filter and finally impinges directly onto the detector or following another optical device.

Preferred exemplary embodiments of the invention are disclosed in the dependent claims.

### BRIEF DESCRIPTION OF THE DRAWINGS

The invention is explained in further detail using exemplary embodiments and with the aid of the Figures, showing in:

FIG. 1 A luminometer with an injection device according to the invention, shown in a cross-sectional representation;

FIG. 2a A microplate and an injection device shown in a perspective representation;

FIG. 2b The injection device from FIG. 2a as seen from a different viewing angle; and

FIG. 3 A combined luminometer and fluorometer, shown in a representation that corresponds to the one in FIG. 1.

### DETAILED DESCRIPTION OF THE INVENTION

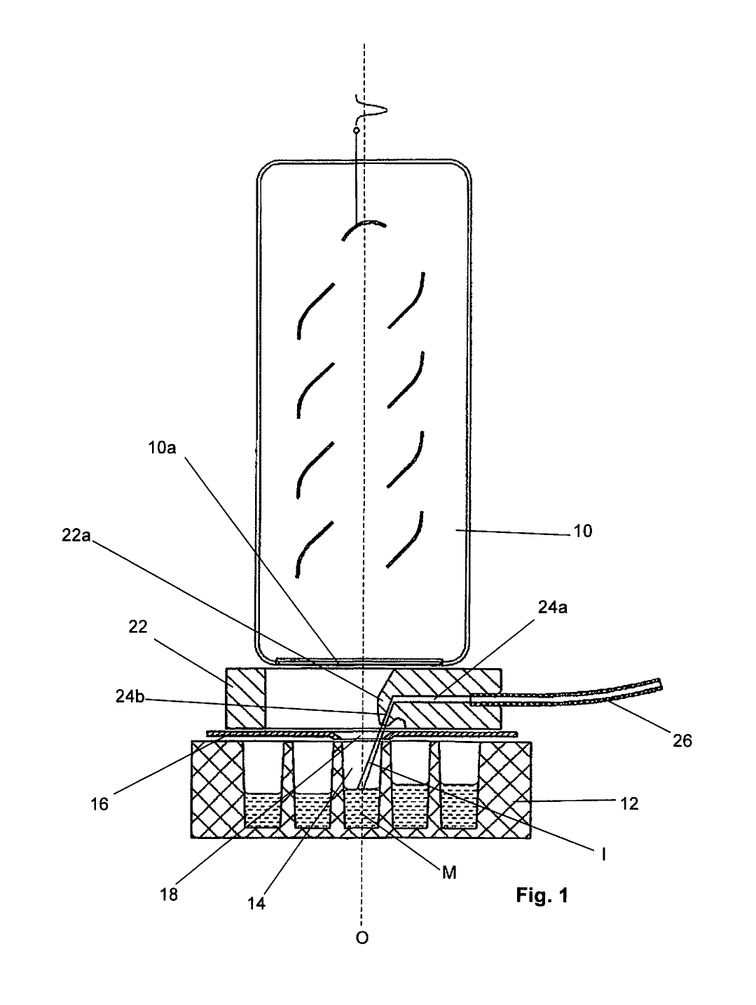

FIG. 1 shows a luminometer. The samples M to be measured are positioned inside the wells 14 of a microplate 12. The longitudinal axis of a well 14, along which the measuring takes place, defines an optical axis O-O that is perpendicular to the surface of the microplate 12. As a rule, this optical axis O-O is also perpendicular to the surface of the measuring sample M which is generally in a liquid form. A detector embodied as photomultiplier 10 in this case is arranged above the sample M to be measured. As can be seen in FIG. 1, this detector is located in the optical axis O-O, which means in concrete terms that the optical axis O-O intersects perpendicular with the entrance window 10a of the photomultiplier 10. It would also be possible for the detector to be arranged in the optical axis O-O via a mirror, a prism, or any other optical deflection means.

Located directly above the microplate 12 is an aperture 16 with an aperture opening 18, the lower edge of which is located in a plane that also extends perpendicular to the optical axis O-O. The aperture can take the form of a sealing element, for example displaceable in vertical direction, with an aperture opening as disclosed in the document EP 1 279 948.

Arranged between the aperture 16 and the entrance window for the photomultiplier 10 is an injection device 20 which, for the exemplary embodiment shown herein, consists of a ring-shaped supporting body 22 with a tube 26 leading to this supporting body. An injection channel consisting of a first section 24a and a second section 24b extends inside the ring-shaped supporting body 22, wherein this ring-shaped supporting body has an inside diameter that is considerably larger than the aperture opening 18. The injection channel may have for example a diameter of 0.5 to 0.8 mm. The first section 24a extends from the outside wall of the supporting body in essentially horizontal direction, meaning perpendicular to the optical axis O-O, to above the sample. The second and relatively short section 24b which adjoins the first section is angled, relative to the first section 24a, and points downward. The second section is tapered so as to end in a tip with the discharge opening 24c, wherein the second section 24b points in the direction of the measuring sample M. The tip is shaped in such a way that no liquid can splash toward the outside during the injection and that the injection stream cuts off cleanly once the injection is finished. The transition between the first section 24a and the second section 24b is located in the region where the ring-shaped supporting body 22 has an outward bulge 22a, wherein the bulge is embodied with the lowest possible wall thickness to ensure that the lowest possible amount of light is absorbed or scattered between the sample and the photocathode.

The ring-shaped supporting body 22 is provided with a thread on the outside so that the tube 26, coming from an injector, can be connected with the aid of a coupling. The material of the supporting body 22 can be transparent or not transparent and should not interact with the reagents, so that neither the reagents nor the material of the supporting body will sustain damage. The sensitivity is somewhat higher with the transparent embodiment, but there is also the danger of phosphorescence.

As a result of the selected geometry, the entrance window of the detector can be located very near the measuring sample M, so that nearly the total luminescence light exiting from the well 14 impinges directly on the entrance window of the detector. With this arrangement, it is achieved that the photocathode can be positioned at a distance of only approximately 10 mm above the entrance aperture, thereby reaching high sensitivities without the use of reflectors.

If no injection is needed in the measuring position, the injection device 20 can be removed easily and the photomultiplier can be lowered even further, so as to achieve the maximum sensitivity for luminescence measurements in that case.

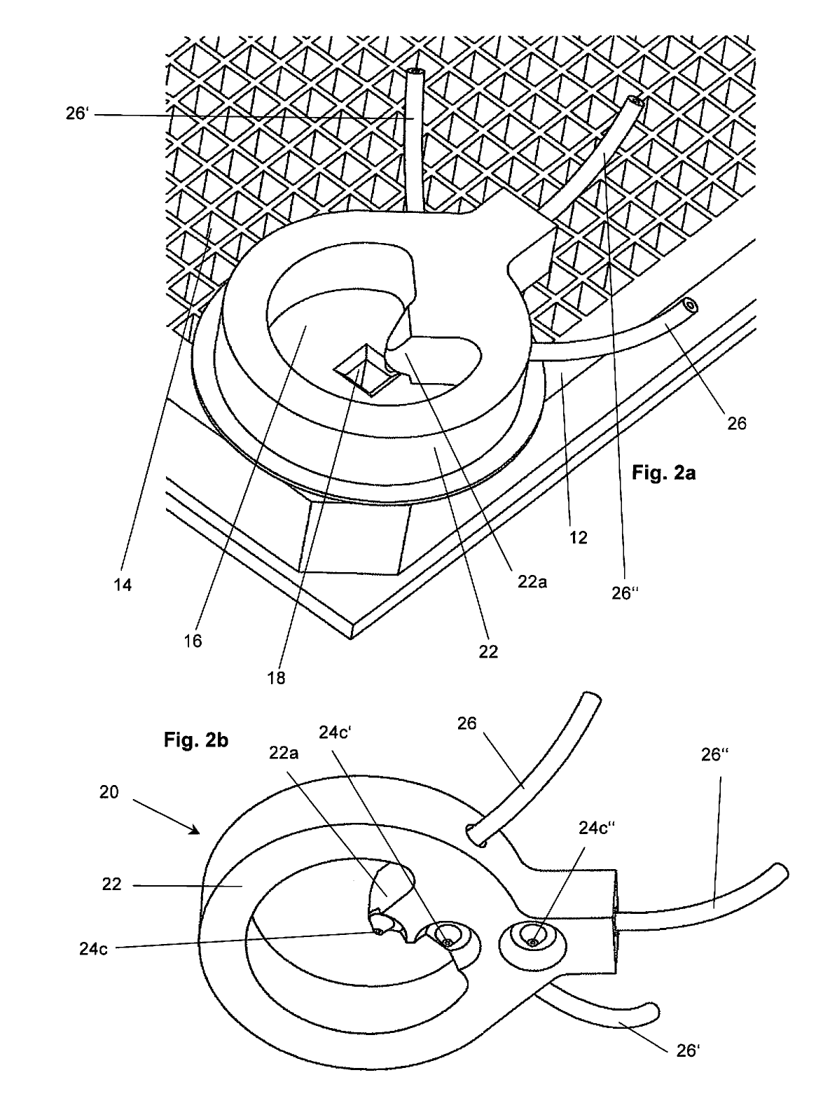

FIGS. 2a and 2b show an injection device 20 in a perspective representation. As can be seen in particular in FIG. 2b, several discharge openings, namely three discharge openings 24c, 24c′ and 24c″ exist, wherein the injection means are fed in via the tubes 26, 26′ and 26″ in accordance with the explanation above, namely with the aid of injection channels that consist of respectively two sections, wherein the first section always extends essentially perpendicular to the optical axis. For the exemplary embodiment shown in FIGS. 2a and 2b, the discharge openings 24c to 24c″ are positioned in a line or row and are therefore assigned wells 14, which are arranged in a row, wherein the aperture 16 in this case must be provided with two additional openings besides the aperture opening 18 (not shown herein). As a result, a reagent can be supplied to the sample prior to the actual measuring operation.

In the case of microplates with 384 wells (cups) with square cross-section, the injector tips are preferably positioned so as to be located above a diagonal line which may be above the wells or somewhat to the side thereof. If applicable, the injection may not occur in a vertical downward direction, but at a downward angle, in the direction toward the opposite edge.

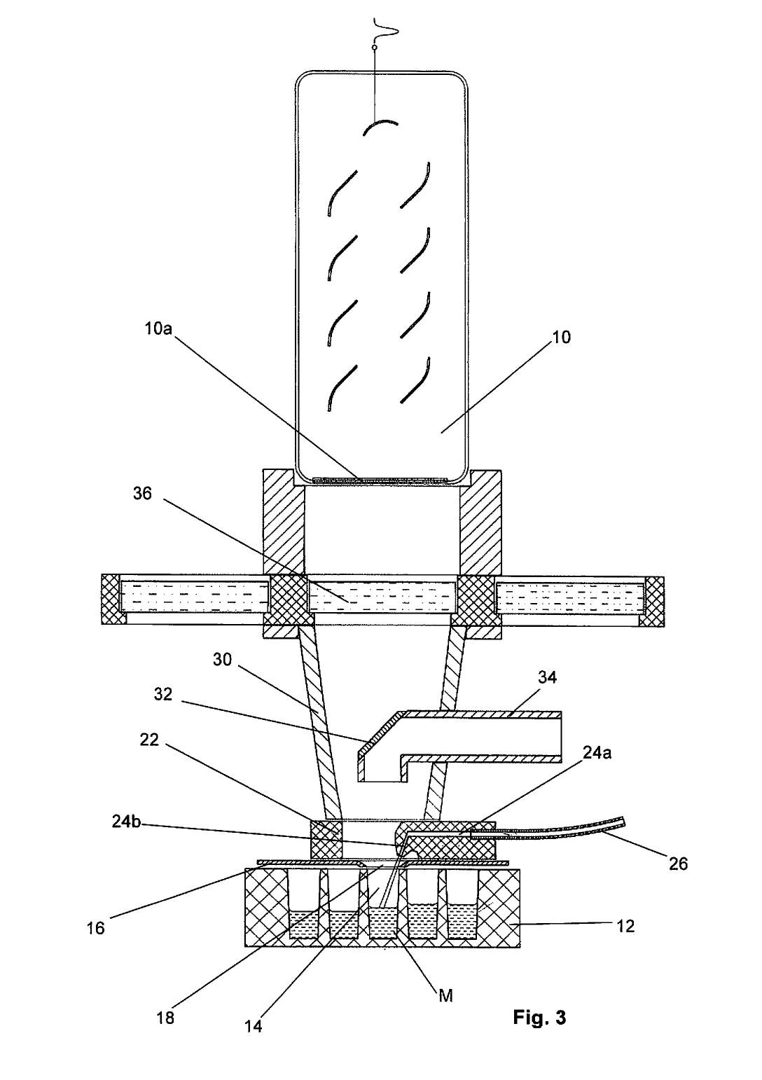

FIG. 3 shows a combined fluorometer and luminometer in a representation corresponding to FIG. 1. The excitation light is provided by a minor 32 which is arranged above the injection device 20 inside a light-impermeable tube 34. This mirror is located inside a reflector 30 which guides the luminescence or fluorescence light exiting from the measuring sample M with parallel orientation to an emissions filter 36 that is arranged upstream of the photomultiplier 10. The geometry of the injection device 20, which is identical to the injection device described for the first exemplary embodiment, in this case has the advantage that the reflector 30, for example having a paraboloid shape on the inside, can be moved to be very close to the measuring sample, without requiring that a section of the injection device extends through it. Once the excitation light is turned off, this device functions as a luminometer.

According to a different embodiment, not shown in the Figures, two thin tube sections extend horizontally into the measuring chamber for supplying the reagent, wherein these tube sections are tapered so as to end in tips. The tube sections are bent downward above the sample, so that the tips point toward the sample positions, wherein the bending is such that the cross section in the bending region is practically not reduced. The tube sections are also held by a supporting body provided with a thread or other connecting option for the tubes coming from the injectors.

### REFERENCE NUMBER LIST

10 photomultiplier
10a entrance window
12 microplate or microtiter plate
14 well
16 aperture
18 aperture opening
19 additional opening
20 injection device
22 ring-shaped supporting body
22a outward bulging section
24a first section
24b second section
24c exit opening
26 tube
30 reflector
32 mirror
34 light-impermeable tube
36 emission filter
O-O optical axis
M measuring sample
I injection stream

What is claimed is:

1. A luminometer or fluorometer with:
an optical axis which extends essentially perpendicular to the measuring sample;
a detector which is positioned either directly or via an optical deflection means in the optical axis;
an injection device which is provided with an injection channel, wherein the injection channel comprises a first section and a second section which is angled relative to the first section, so as to point in the direction of the measuring sample, further comprising a discharge opening that points in the direction of the measuring sample,
characterized in that the first section of the injection channel extends essentially perpendicular to the optical axis and that at least one second injection device is provided which also comprises an injection channel with two sections, wherein the first section extends essentially perpendicular to the optical axis and the second section is angled relative to the first section and ends in a discharge opening.

2. The luminometer or fluorometer according to claim 1, characterized in that the first section extends practically at a horizontal orientation.

3. The luminometer or fluorometer according to claim 1, characterized in that it comprises at least one aperture with an aperture opening, for which the lower edge that points away from the detector defines a first plane which extends perpendicular to the optical axis.

4. The luminometer or fluorometer according to claim 3, characterized in that the distance between the first plane and the first section of the injection channel is maximum 10 mm.

5. The luminometer or fluorometer according to claim 3, characterized in that the aperture is provided with an additional opening besides the aperture opening, wherein the discharge opening of the second injection device points toward the additional opening.

6. The luminometer or fluorometer according to claim 5, characterized in that three injection devices with discharge openings arranged in a row are provided.

7. The luminometer or fluorometer according to claim 1, characterized in that at least the first section (24a) of the injection channel extends through a supporting body.

8. The luminometer according to claim 7, characterized in that the first section extends from the outside wall of the supporting body in horizontal direction into the supporting body.

9. The luminometer or fluorometer according to claim 7, characterized in that at least the first section of the injection channel takes the form of a bore in the supporting body.

10. The luminometer or fluorometer according to claim 9, characterized in that a bulging section extends outward from the supporting body in which the transition from the first to the second section is located.

11. The luminometer or fluorometer according to claim 3, characterized in that the supporting body is ring-shaped and surrounds the aperture opening.

12. The luminometer or fluorometer according to claim 11, characterized in that the supporting body connects the aperture and the detector, so as to be impermeable to light.

13. The luminometer or fluorometer according to claim 1, characterized in that the injection channel extends inside a bent tube or a bent tubule.

14. The luminometer or fluorometer according to claim 1, characterized in that the angle between the first and the second section of the injection channel is between 90° and 135°.

15. The luminometer or fluorometer according to claim 1, characterized in that above the injection device excitation light can be conducted onto the measuring sample with the aid of a mirror that is angled by 45°, as compared to the optical axis, and that light emitted by the measuring sample can be parallelized above the injection device with the aid of a parabolic reflector.
